(19) United States
(12) Patent Application Publication
(10) Pub. No.: US 2015/0278910 A1
(43) Pub. Date: Oct. 1, 2015

(54) Directed Recommendations

(71) Applicant: Microsoft Corporation, Redmond, WA (US)

(72) Inventors: Nir Nice, Kfar Veradim (IL); Noam Koenigstein, Raanana (IL); Ulrich Paquet, Cambridge (GB); Yehuda Finkelstein, Aley-Zahar (IL)

(73) Assignee: Microsoft Corporation, Redmond, WA (US)

(21) Appl. No.: 14/230,028

(22) Filed: Mar. 31, 2014

(51) Int. Cl. G06Q 30/06

(52) U.S. Cl. CPC G06Q 30/0631

(57) ABSTRACT

Example apparatus and methods perform matrix factorization (MF) on a usage matrix to create a latent space that describes similarities between items in the usage matrix. The usage matrix relates source items that a user already has to target items that a user might acquire. A cell in the usage matrix may store a value that describes the likelihood (e.g., probability) that an acquisition of item x will lead to an acquisition of item y. The value stored in cell (x,y) is not transitive with the value stored in cell (y,x). Values that are missing in the usage matrix may be computed using vectors in the latent space. Once the usage matrix is updated, a directed recommendation may be produced from data in the usage matrix. Initial values in the usage matrix may be produced from data associated with actual acquisitions.

### BACKGROUND

Conventional recommendation systems provide information about matches between users (e.g., shoppers) and items (e.g., books, videos, games) based on user interests, preferences, history, or other factors. For example, if a user has previously acquired (e.g., purchased, rented, borrowed, played) a set of items, then a recommendation system may identify similar items and recommend them to the user based on the user's own actions. Conventional recommendation systems may also determine similarities between users or between items and make additional recommendations based on those similarities. For example, if users in a certain demographic and with similar acquisition histories and preferences have acquired a set of items, then a recommendation system may identify items and recommend them to a user based on the actions of other users.

There are two major types of conventional recommendation systems: collaborative filtering based systems and content based systems. Content based systems may also be referred to as “feature based” systems. Collaborative filtering depends on actual user events (e.g., user who bought/watched/read A then bought/watched/read B). Feature based systems describe features (e.g., author, actor, genre) of items. Different techniques (e.g., matrix factorization, nearest neighbor) may be used to compute item similarities and then to provide recommendations based on the similarities. Conventional systems assume that similarities are symmetrical (e.g., transitive), so that knowing that a user who acquired A then acquired B implies that a user who acquires B might want to acquire A next. This assumption produces sub-optimal results with respect to, for example, a basket recommendation, a sequel recommendation, a family or products recommendation, or other recommendations. For example, it may make sense to recommend a movie sequel (e.g., Rocky II) to a purchaser of a predecessor movie (e.g., Rocky). However, it may not make as much sense to recommend a predecessor movie (e.g., Rocky II) to a purchaser of a sequel movie (e.g., Rocky IV). Similarly, it may make sense to recommend the purchase of productivity software to a purchaser of a laptop computer, but it may not make as much sense to recommend the purchase of a laptop computer to the purchaser of productivity software.

Conventional matrix factorization models map both users and items to a joint latent factor space of dimensionality f and model user-item interactions as inner products in the joint factor space. An item may be associated with an item vector whose elements measure the extent to which the item possesses some factors. Similarly, a user may be associated with a user vector whose elements measure the extent of interest the user has in items that are high in corresponding factors. The dot product of the vectors may describe the interaction between the user and item and may be used to determine whether to make a recommendation to a user. More specifically, every user i may be assigned a vector uᵢ in a latent space, and every item j may also be assigned a vector vⱼ in the latent space. The dot product uᵢ·vⱼ represents the score between the user i and the item j. The score represents the strength of the relationship between the user i and the item j and may be used to make a recommendation (e.g., recommend item with highest score). The user-item matrix may capture relationships between users and items, and the joint latent factor space may capture relationships between some items, however, the direction of the relationship may not be captured.

In conventional systems, when computing recommendations for a specific user i using matrix factorization, all the items j in the catalog may be scored. After all the items j have been scored, the highest scoring items may be selected. This may be represented as: given i, find j=arg max uᵢ·vⱼ. In mathematics, arg max is the argument of the maximum, which is defined as the set of points of the given argument for which the given function attains its maximum value.

$$arg {max}_{x} f ( x ) := \{ x \vert ∀ y \text{:} f ( y ) \leq f ( x ) \}$$

In other words, arg maxₓ f (x) is the set of values of x for which f(x) attains its largest value M. For example, if f(x) is 1−|x| then it attains its maximum value of 1 at x=0 and only there, so arg maxₓ (1−|x|)={0}. While finding the maximum scoring item for a user may produce an adequate result, when the scoring is based on the assumption that similarities are symmetrical, or when the scoring does not account for the order in which items are acquired, then undesirable results may be produced.

### SUMMARY

This Summary is provided to introduce, in a simplified form, a selection of concepts that are further described below in the Detailed Description. This Summary is not intended to identify key features or essential features of the claimed subject matter, nor is it intended to be used to limit the scope of the claimed subject matter.

Example apparatus and methods compute a directed (e.g., non-transitive) similarity for items. The directed similarly facilitates accounting for the order in which items can be recommended. Accounting for the order facilitates identifying that ownership of a first item may imply a good recommendation for the purchase of a second item, but that ownership of the second item may not imply a good recommendation for the purchase of the first item. Conventional systems may only see the relationship between the two items and not the predecessor/successor or directed relationship. Example apparatus and methods provide recommendations (e.g., item-to-item, basket-to-item, user-to-item) based on non-transitive similarities, which may produce superior results with respect to order when compared to conventional systems. Rather than start with a user to item matrix, a source item to target item matrix may be subjected to matrix factorization. A source item vector may be associated with an item that a user already has and a target item vector may be associated with an item that a user may be interested in after acquiring the source item. Some prior knowledge about the likelihood that a purchaser of one item is followed by the purchase of another item may be employed to build the source item vector and target item vector matrix. For example, data from a sales data base may be examined. The data may describe when items were purchased or the order in which items were purchased.

In one example, an apparatus includes a memory that stores a latent space (e.g., item model) created by performing matrix factorization on the source item to target item matrix rather than on a user to item matrix. In the source item to target item matrix, the probability that the purchase of item i is followed by the purchase of item j may not be the same as the probability that the purchase of item j is followed by the purchase of item i (e.g., {i→j}≠Pr{j→i}). For example, data concerning the order in which items were purchased may store probability data in the source item to target item matrix. Data that j was purchased after i will produce a first probability Pr{i→j} while data that i was purchased after j will produce a second, different probability Pr{j→i}. The item model represented by the latent space is an item to item model that does not model users and that does not directly model a relationship between a user and a specific item. Instead, the item model represented by the latent space models relationships between items. The matrix factorization performed on the source item to target item matrix therefore learns the latent representations of source vectors and target vectors, which can be used to fill in holes missing in the source item to target item matrix, which in turn facilitates making improved recommendations from the source item to target item matrix. In one embodiment, matrix factorization may be performed on a basket of items (e.g., two or more) to an item.

### BRIEF DESCRIPTION OF THE DRAWINGS

The accompanying drawings illustrate various example apparatus, methods, and other embodiments described herein. It will be appreciated that the illustrated element boundaries (e.g., boxes, groups of boxes, or other shapes) in the figures represent one example of the boundaries. In some examples, one element may be designed as multiple elements or multiple elements may be designed as one element. In some examples, an element shown as an internal component of another element may be implemented as an external component and vice versa. Furthermore, elements may not be drawn to scale.

FIG. 1 illustrates an example source item to target item matrix.

FIG. 2 illustrates an example metric space.

FIG. 3 illustrates an example method associated with producing a directed recommendation based on non-transitive similarity data.

FIG. 4 illustrates an example method associated with producing a directed recommendation based on non-transitive similarity data.

FIG. 5 illustrates an example apparatus associated with producing a directed recommendation based on non-transitive similarity data.

FIG. 6 illustrates an example apparatus associated with producing a directed recommendation based on non-transitive similarity data.

FIG. 7 illustrates an example cloud operating environment in which a directed recommendation system may operate based on non-transitive similarity data.

FIG. 8 is a system diagram depicting an exemplary mobile communication device configured to participate in a directed recommendation system based on non-transitive similarity data.

### DETAILED DESCRIPTION

Example apparatus and methods provide a recommendation system that builds an item-to-item latent item model from a source item to target item matrix. Example apparatus and methods build the initial source item to target item matrix using non-transitive similarity data that describes Pr{i→j} and Pr{j→i}. The latent item model is built by performing matrix factorization (MF) on the source item to target item matrix. In one embodiment, MF may be performed on single items to single items. In another embodiment, MF may be performed on a basket of items (e.g., two or more items) to single items. MF is an operation by which a sparse usage matrix may be converted to a latent item model. Source items refers to item(s) a user(s) already has. Target items refers to item(s) a user(s) may acquire after acquiring the source item(s). The sparse usage matrix may have, for example, rows that denote source items and columns that denote target items. If the usage matrix is referred to as matrix M, then a cell m(i,j) in M may store the probability of acquiring (e.g., buying, playing, viewing) item j after acquiring item i. Note that the value of m(i,j) may not equal the value of m(j,i), or Pr{i→j}≠Pr{j→i}). The value of m(i,j) may not equal the value of m(j,i) because people buy things in certain orders. For example, people tend to buy a series of movies in order, or tend to buy base items first and then purchase upgrades. Conventional systems only capture the fact that a user owns both items, not that one item is bought before another item.

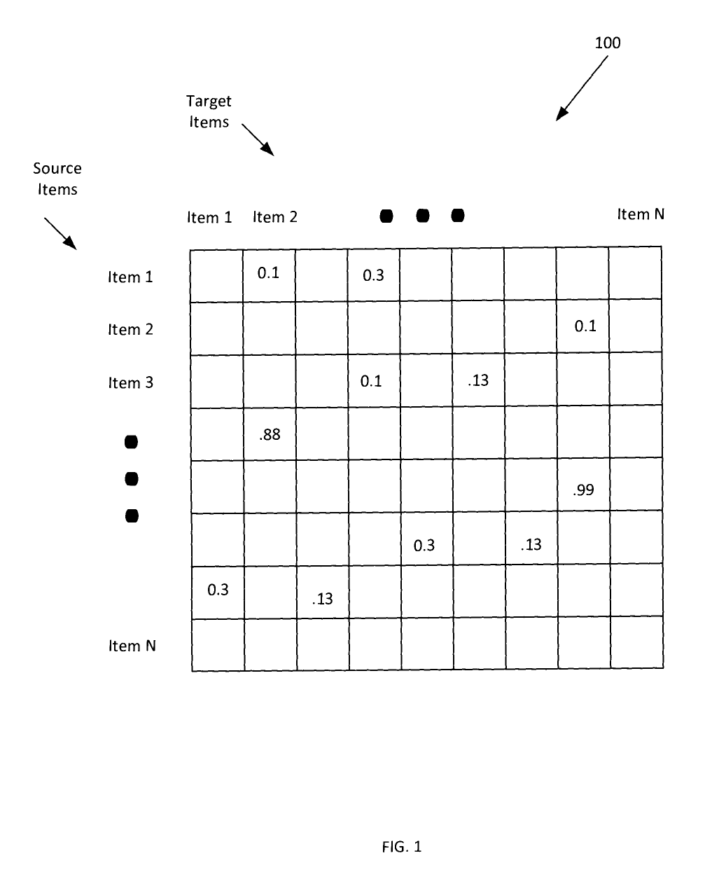

FIG. 1 illustrates a source item to target item matrix 100. Cells in the matrix 100 denote the probability of a source item acquisition being followed by a target item acquisition. For example, a cell with a value 0.01 indicates that it is very unlikely that purchasing the source item will be followed by purchasing the target item, but a value of 0.83 indicates that it is very likely that purchasing the source item will be followed by purchasing the target item. Different values may be used in different examples. The value for most pairs of items may be unknown. However, the value for some pairs of items may be known. A value may be known, for example, from analytics performed on purchases, from purchase histories, or from other techniques. For example, a purchase history for a user may show the order in which two specific items were purchased. The purchase database may show how many of each of the two specific items were purchased. By examining user purchase histories and comparing sequences of purchases with an overall number of purchases, a likelihood may be determined.

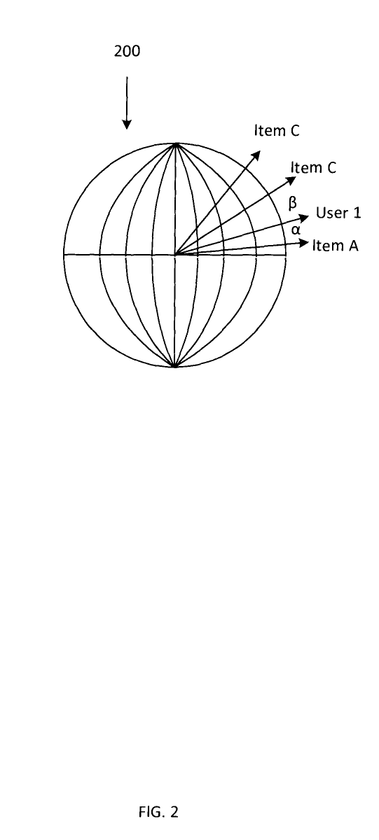

FIG. 2 illustrates a metric space 200 where the distance between items is defined. For example, the distance between a first vector and a second vector may be measured by angle α and the distance between the second vector and a third vector can be measured by β. The distance between items may describe, for example, how similar the items are. While distance is illustrated being measured by angles, other distance measuring approaches may be applied. Conventionally, the metric space 200 may have been created by performing matrix factorization on a user to item matrix and thus the distance between a user item and vector item could be found. Example apparatus and methods learn a latent representation of source item vectors and target item vectors. The distance between source and target items may describe, for example, how likely it is that one purchase will follow another. A source item i is associated with a k-dimensional vector. The source vector for item i is represented by Si while the target vector for item i is represented by Ti. The source vector for item j is represented by Sj while the target vector for item j is represented by Tj. Pr{i→j} denotes the probability that a user with item i will acquire (e.g., purchase, view, play) item j. The value for Pr{i→j} may be known for some pairs but may be unknown for some other pairs. Example apparatus and methods may calculate scores that are unknown from the scores that are known. In one embodiment, a basket vector may be produced for the metric space. The basket vector may be produced by performing MF on a basket of items with respect to a single item.

The probability Pr{i→j} may be modelled using Pr{i→j}=sᵢ·tⱼ, where sᵢ·tⱼ represents the inner product or scalar product of the source vector for i and the target vector for j. While the inner product is used as one example, the probability Pr{i→j} may be modelled in other ways. When the probability Pr{i→j} is modelled using Pr{i→j}=sᵢ·tⱼ, then the relationship between source item vectors and target item vectors is defined in a way that facilitates solving for missing source item vectors and missing target item vectors in the latent space. When missing source item vectors and missing target item vectors have been learned in the latent space, then the learned vectors can be used to predict probabilities Pr{i→j} for which there was no known value in the source item to target item matrix. Some of the {i→j} relationships are known (e.g., observed) and some of the {i→j} relationships are unknown. Example apparatus and methods learn source and target vectors that explain or best describe the observed data or evidence. The learned vectors are then employed to predict relationships that are missing in the usage matrix.

Once additional scores have been added to the source item to target item matrix, then the matrix can be used to make improved recommendations. For example, given a source item, values for target items can be retrieved, and a recommendation(s) can be made based on the target item values. In different examples, the highest valued item can be recommended, a threshold number of the highest valued items can be recommended, or other subsets of target items may be selected based on the target value scores.

Recall that unlike conventional systems, P{i→j}≠Pr{j→i}. Thus, a purchaser of a video game (e.g., FIFA 12) may have FIFA 13 or FIFA 14 recommended to them but may not have FIFA '09 or FIFA '07 recommended to them. Similarly, a purchaser of a tablet may have tablet skins recommended to them, while a purchaser of a tablet skin may not have a tablet recommended to them. The non-transitive or directed recommendation will present more accurate recommendations to users so that unlike conventional systems, an item that is a prerequisite to having an already purchased item will not be shown as a recommendation.

Some portions of the detailed descriptions that follow are presented in terms of algorithms and symbolic representations of operations on data bits within a memory. These algorithmic descriptions and representations are used by those skilled in the art to convey the substance of their work to others. An algorithm is considered to be a sequence of operations that produce a result. The operations may include creating and manipulating physical quantities that may take the form of electronic values. Creating or manipulating a physical quantity in the form of an electronic value produces a concrete, tangible, useful, real-world result.

It has proven convenient at times, principally for reasons of common usage, to refer to these signals as bits, values, elements, symbols, characters, terms, numbers, distributions, and other terms. It should be borne in mind, however, that these and similar terms are to be associated with the appropriate physical quantities and are merely convenient labels applied to these quantities. Unless specifically stated otherwise, it is appreciated that throughout the description, terms including processing, computing, and determining, refer to actions and processes of a computer system, logic, processor, system-on-a-chip (SoC), or similar electronic device that manipulates and transforms data represented as physical quantities (e.g., electronic values).

Example methods may be better appreciated with reference to flow diagrams. For simplicity, the illustrated methodologies are shown and described as a series of blocks. However, the methodologies may not be limited by the order of the blocks because, in some embodiments, the blocks may occur in different orders than shown and described. Moreover, fewer than all the illustrated blocks may be required to implement an example methodology. Blocks may be combined or separated into multiple components. Furthermore, additional or alternative methodologies can employ additional, not illustrated blocks.

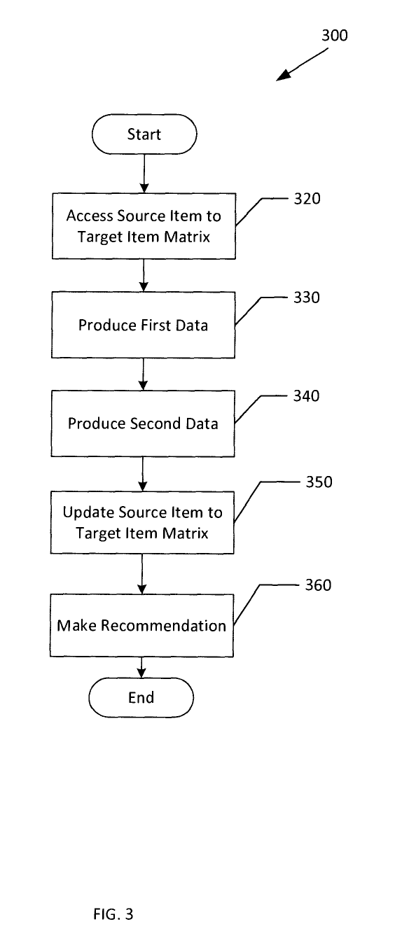

FIG. 3 illustrates an example method 300 associated with producing a directed recommendation based on non-transitive similarity data. Method 300 may include, at 320, accessing a usage matrix (M) that stores electronic data concerning a set of source items and a set of target items. In one embodiment, the source items may be represented in rows in the usage matrix and the target items may be represented in columns in the usage matrix. The electronic data stored in the usage matrix describes the likelihood that an acquisition of a source item i will be followed by an acquisition of a target item j. In different embodiments, the acquisition of i may involve making a purchase, playing a game, reading a book, watching a display, or other action.

i may be described by a vector mᵢ associated with the usage matrix and j may be described by a vector mⱼ associated with the usage matrix. Recall that the elements of a vector measure the extent to which the entity associated with the vector possesses the factors associated with the dimensions in M. The likelihood of acquiring j after i is not symmetrical with the likelihood of acquiring i after j.

Method 300 may also include, at 330, producing, from M, first electronic data associated with a latent item space. The first electronic data may be produced using a matrix factorization process for vectors associated with members of the set of source items and vectors associated with members of the set of target items. The first electronic data may include a vector uⱼ that represents i and a vector vⱼ that represents j. Unlike conventional systems that produce a latent space from a user to item matrix, method 300 may produce the latent space from the source item to user item matrix.

Method 300 may also include, at 340, producing, from the first electronic data, second electronic data that represents a likelihood that an acquisition of a first item in M will be followed by an acquisition of a second item in M. In one embodiment, the likelihood that an acquisition of i will be followed by an acquisition of j is a probability Pr{i→j}. Since the likelihood data is not directed, Pr{i→j}≠Pr{j→i}, Pr{i→j} is not transitive with Pr{j→i}, and Pr{i→j} is not computed from Pr{j→i}.

To facilitate computing the second electronic data, Pr{i→j} may be defined according to: Pr{i→j}=sᵢ·tⱼ, where sᵢ·tⱼ represents the inner product of the vector Si in the latent space and the vector for Tj in the latent space. Producing the second electronic data may depend, at least in part, on computing sᵢ·tⱼ.

Method 300 may also include, at 350, storing the second electronic data in the usage matrix M. Thus, vectors produced by matrix factorization on a previous instance of the usage matrix may be used to add data to a subsequent instance of the usage matrix. Improved recommendations may then be made from the subsequent instance of the usage matrix.

Method 300 may also include, at 360, producing a recommendation concerning an item in M to be acquired. The recommendation is based, at least in part, on data in M. Method 300 may make different types of recommendations. For example, the recommendation may be an item-to-item recommendation, a basket-to-item recommendation, or a user-to-item recommendation. In one embodiment, to facilitate making a basket-to-item recommendation, matrix factorization may be performed on baskets of items (e.g., two or more items) to single items. In one embodiment, all possible source baskets may be processed (e.g., matrix factorized) with respect to single items. In another embodiment, all baskets of two or three items may be processed with respect to single items. In yet another embodiment, a sample of baskets may be processed with respect to single items.

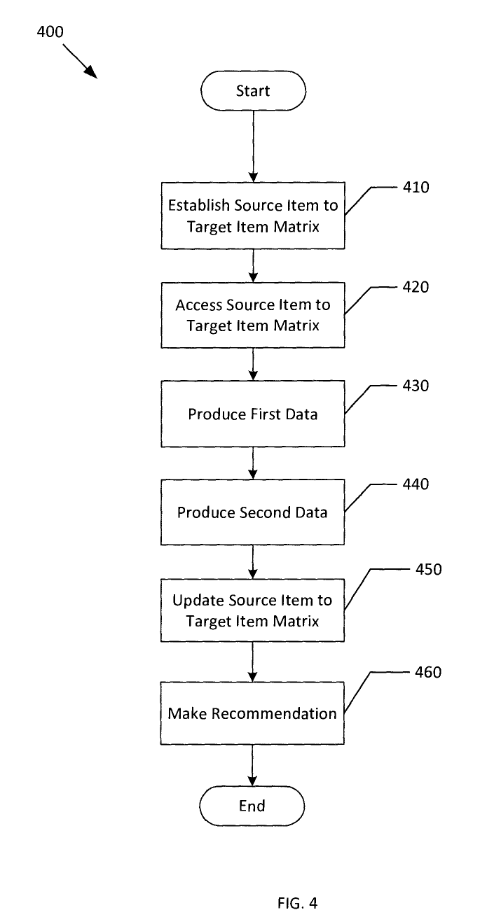

FIG. 4 illustrates an example method 400 associated with producing a directed recommendation based on non-transitive similarity data. Method 400 includes several actions similar to method 300. For example, method 400 includes, accessing the usage matrix at 420, producing a latent space at 430, producing data to update the usage matrix at 440, updating the usage matrix at 450, and making a recommendation at 460.

However, this embodiment of method 400 may also include, at 410, establishing the usage matrix M. M may be established by storing a value in a cell (a,b) in M. The value stored in the cell (a,b) represents the likelihood that an acquisition of a source item a will lead to an acquisition of a target item b. When establishing the usage matrix M, the value in cell (a,b) may be based on actual acquisition data. Since the value is based on actual acquisition data, unlike conventional systems the value in cell (a,b) is not computed from the value in cell (b,a) and is not symmetrical with the value in cell (b,a).

While FIGS. 3 and 4 illustrates various actions occurring in serial, it is to be appreciated that various actions illustrated in FIGS. 3 and 4 could occur substantially in parallel. By way of illustration, a first process could build an initial source item to target item matrix, a second process could produce a latent space from the source item to target item matrix, a third process could fill in blanks in the source item to target item matrix based on the vectors learned in the latent space, and a fourth process could make recommendations from the improved source item to target item matrix. While four processes are described, it is to be appreciated that a greater or lesser number of processes could be employed and that lightweight processes, regular processes, threads, and other approaches could be employed.

In one example, a method may be implemented as computer executable instructions. Thus, in one example, a computer-readable storage medium may store computer executable instructions that if executed by a machine (e.g., computer) cause the machine to perform methods described or claimed herein including methods 300 or 400. While executable instructions associated with the above methods are described as being stored on a computer-readable storage medium, it is to be appreciated that executable instructions associated with other example methods described or claimed herein may also be stored on a computer-readable storage medium. In different embodiments the example methods described herein may be triggered in different ways. In one embodiment, a method may be triggered manually by a user. In another example, a method may be triggered automatically.

“Computer-readable storage medium”, as used herein, refers to a medium that stores instructions or data. “Computer-readable storage medium” does not refer to propagated signals, per se. A computer-readable storage medium may take forms, including, but not limited to, non-volatile media, and volatile media. Non-volatile media may include, for example, optical disks, magnetic disks, tapes, flash memory, read only memory (ROM), and other media. Volatile media may include, for example, semiconductor memories, dynamic memory (e.g., dynamic random access memory (DRAM), synchronous dynamic random access memory (SDRAM), double data rate synchronous dynamic random-access memory (DDR SDRAM), etc.), and other media. Common forms of a computer-readable storage medium may include, but are not limited to, a floppy disk, a flexible disk, a hard disk, a magnetic tape, other magnetic medium, a compact disk (CD), a random access memory (RAM), a read only memory (ROM), a memory chip or card, a memory stick, and other media from which a computer, a processor or other electronic device can read.

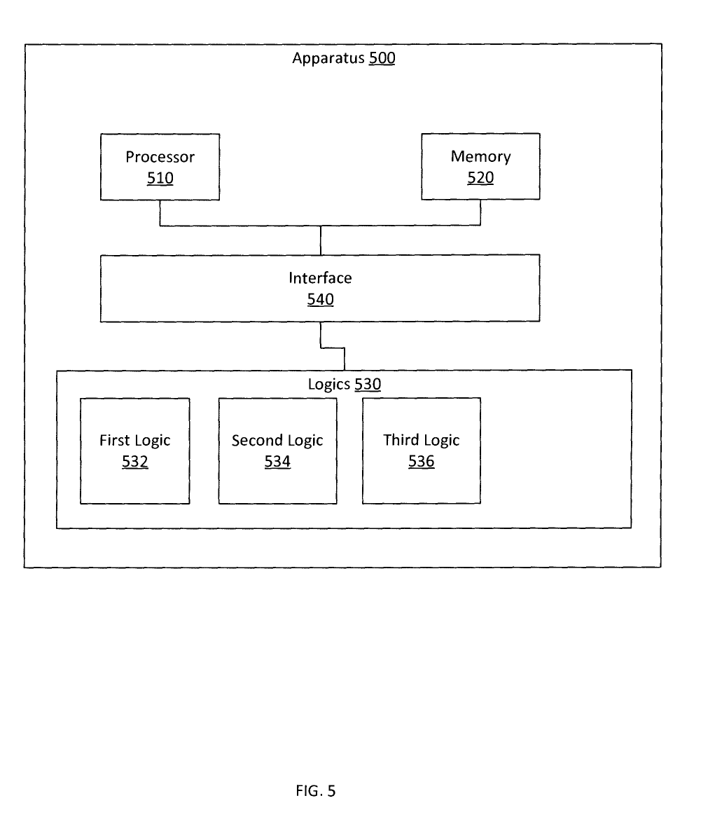

FIG. 5 illustrates an apparatus 500 that produces a directed recommendation based on non-transitive similarity data. Apparatus 500 may include a processor 510, a memory 520, a set 530 of logics, and an interface 540 that connects the processor 510, the memory 520, and the set 530 of logics. The processor 510 may be, for example, a microprocessor in a computer, a specially designed circuit, a field-programmable gate array (FPGA), an application specific integrated circuit (ASIC), a processor in a mobile device, a system-on-a-chip, a dual or quad processor, or other computer hardware. The memory 520 may store data representing non-transitive probabilities, data concerning recommendations, latent space vectors, or other data. The memory 520 may store non-transitive likelihood data associated with a directed recommendation.

In one embodiment, the apparatus 500 may be a general purpose computer that has been transformed into a special purpose computer through the inclusion of the set 530 of logics. Apparatus 500 may interact with other apparatus, processes, and services through, for example, a computer network. Apparatus 500 may be, for example, a computer, a laptop computer, a tablet computer, a personal electronic device, a smart phone, a system-on-a-chip (SoC), or other device that can access and process data.

The set 530 of logics may facilitate producing a directed recommendation. The set 530 of logics may include a first logic 532 that performs matrix factorization (MF) on a usage matrix to create a latent item space. The latent item space may describe similarities between source items and target items in the usage matrix. The similarities may be identified by examining latent vectors in the latent space. Recall that a source item is an item a user has acquired and a target item is an item a user may acquire. Matrix factorization may reduce the dimensionality of the usage matrix. Thus, in one embodiment, the dimensionality of the latent space is lower than the dimensionality of the usage matrix. Thus, vectors in the latent space may have fewer dimensions than vectors associated with the usage matrix.

In one embodiment, a source item i in the usage matrix is represented by a source item vector sᵢ and a target item j in the usage matrix is represented by a target item vector tⱼ. The source item i may be related to the target item j by a value in a cell (i,j) in the usage matrix. The value stored in cell (i,j) describes the likelihood that an acquisition of source item i will lead to the acquisition of target item j. The value stored in cell (i,j) is not transitive with the value stored in cell (j,i). In one embodiment, the value of cell (i,j) in the usage matrix is a probability Pr{i→j}. In this embodiment, Pr{i→j} is not determined by Pr{j→i}.

The set 530 of logics may also include a second logic 534 that computes a value for a cell (p,q) in the usage matrix, p and q being integers. The value for cell (p,q) may be computed if, for example, there was no initial value for cell (p,q). Computing the value for the cell (p,q) may include processing vectors in the latent space. For example, the value for cell (p,q) is computed as a function of a vector in the latent space associated with a source item p and a vector in the latent space associated with a target item q. In one example, computing the value for cell (p,q) may rely on Pr{i→j} being defined according to:

Pr{i→j}=sᵢ·tⱼ,

where sᵢ·tⱼ represents the inner product of the source item vector sᵢ for i and the target item vector tⱼ for j. Computing the value for cell (p,q) may result from computing the inner product. In one embodiment, the second logic 534 may compute values for two or more cells in the usage matrix in parallel. Thus, the first logic 532 may take existing data in the usage matrix and perform matrix factorization that produces latent vectors in a latent space. The second logic 534 may then use the latent vectors to produce additional data for the usage matrix.

The set 530 of logics may also include a third logic 536 that produces a recommendation from the data in the usage matrix. For example, given an initial item (II), the third logic 536 may produce a directed recommendation of a recommended target item (RTI). Recall that a value v(II, RTI) in the usage matrix is not transitive with a value v(RTI,II) in the usage matrix. In one embodiment, the third logic 536 may produce the directed recommendation based on a highest value v=Pr{II→RTI} found in the usage matrix. In another embodiment, the third logic 536 may produce N directed recommendations of N target items to acquire based on rankings of data found in the usage matrix for the initial item, N being an integer greater than one.

Third logic 536 may produce different types of recommendations based on the initial item. For example, the initial item may be an individual source item in the usage matrix and thus the recommendation may be an item-to-item recommendation. In another embodiment, the initial item may be a plurality of source items in the usage matrix and thus the recommendation may be a basket-to-item recommendation. In yet another embodiment, the initial item may be associated with a user and thus the recommendation may be a user-to-item recommendation.

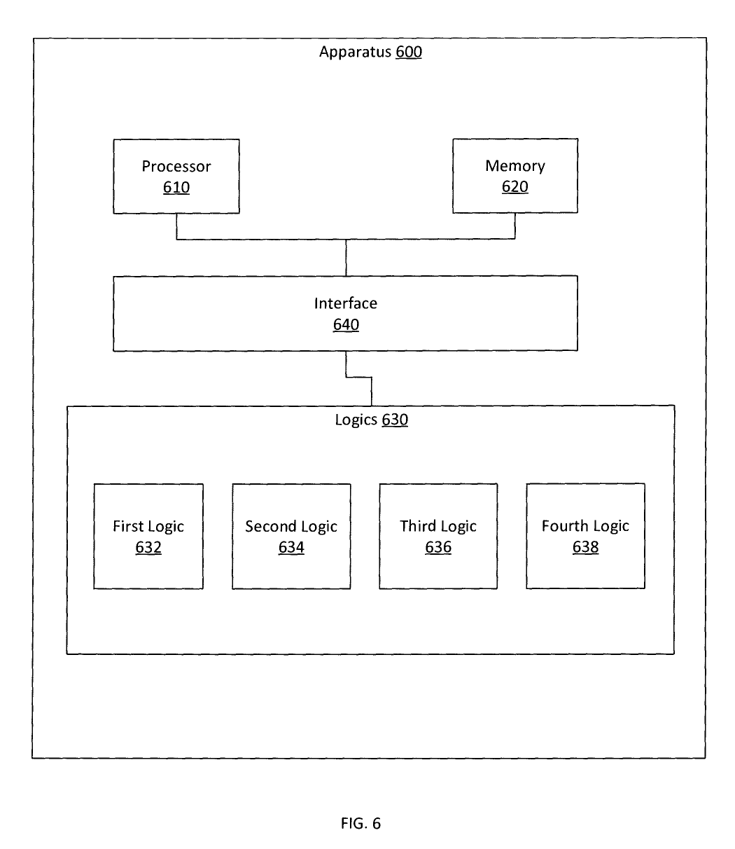

FIG. 6 illustrates an apparatus 600 that is similar to apparatus 500 (FIG. 5). For example, apparatus 600 includes a processor 610, a memory 620, a set of logics 630 (e.g., 632, 634, 636) that correspond to the set of logics 530 (FIG. 5) and an interface 640. However, apparatus 600 includes an additional fourth logic 638. Fourth logic 638 may establish an initial value for a cell in the usage matrix from data associated with actual acquisitions of items represented in the usage matrix. For example, actual sales data, including time of sale, may be analyzed to determine the frequency with which items are bought in which order.

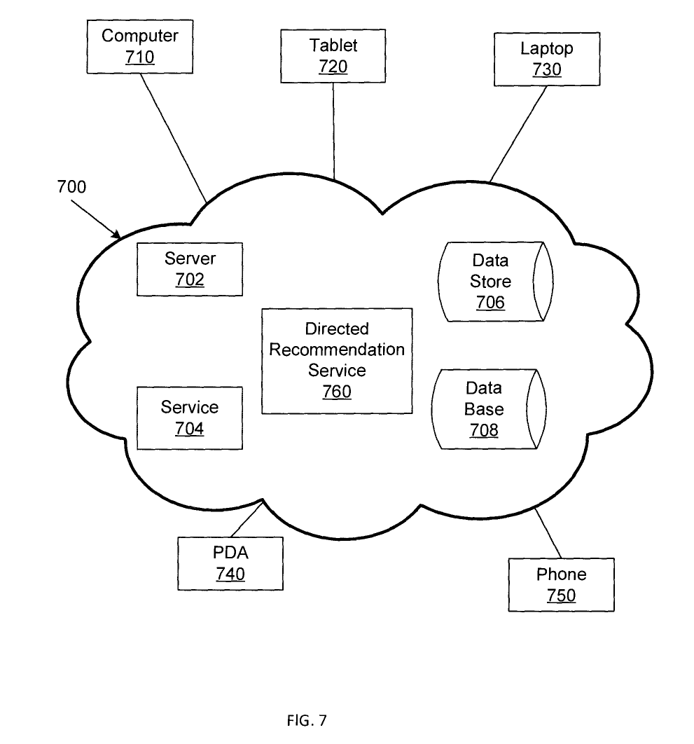

FIG. 7 illustrates an example cloud operating environment 700. A cloud operating environment 700 supports delivering computing, processing, storage, data management, applications, and other functionality as an abstract service rather than as a standalone product. Services may be provided by virtual servers that may be implemented as one or more processes on one or more computing devices. In some embodiments, processes may migrate between servers without disrupting the cloud service. In the cloud, shared resources (e.g., computing, storage) may be provided to computers including servers, clients, and mobile devices over a network. Different networks (e.g., Ethernet, Wi-Fi, 802.x, cellular) may be used to access cloud services. Users interacting with the cloud may not need to know the particulars (e.g., location, name, server, database) of a device that is actually providing the service (e.g., computing, storage). Users may access cloud services via, for example, a web browser, a thin client, a mobile application, or in other ways.

FIG. 7 illustrates an example directed recommendation service 760 residing in the cloud. The directed recommendation service 760 may rely on a server 702 or service 704 to perform processing and may rely on a data store 706 or database 708 to store data. While a single server 702, a single service 704, a single data store 706, and a single database 708 are illustrated, multiple instances of servers, services, data stores, and databases may reside in the cloud and may, therefore, be used by the recommendation service 760.

FIG. 7 illustrates various devices accessing the directed recommendation service 760 in the cloud. The devices include a computer 710, a tablet 720, a laptop computer 730, a personal digital assistant 740, and a mobile device (e.g., cellular phone, satellite phone, wearable computing device) 750. The directed recommendation service 760 may produce a recommendation for a user concerning a potential acquisition (e.g., purchase, rental, borrowing). Additionally, the directed recommendation service 760 may build an initial source item to target item usage matrix, may build a latent space from the usage matrix by performing matrix factorization on the usage matrix, may update the usage matrix based on vectors learned in the latent space, and may make recommendations from the update usage matrix.

It is possible that different users at different locations using different devices may access the directed recommendation service 760 through different networks or interfaces. In one example, the directed recommendation service 760 may be accessed by a mobile device 750. In another example, portions of directed recommendation service 760 may reside on a mobile device 750.

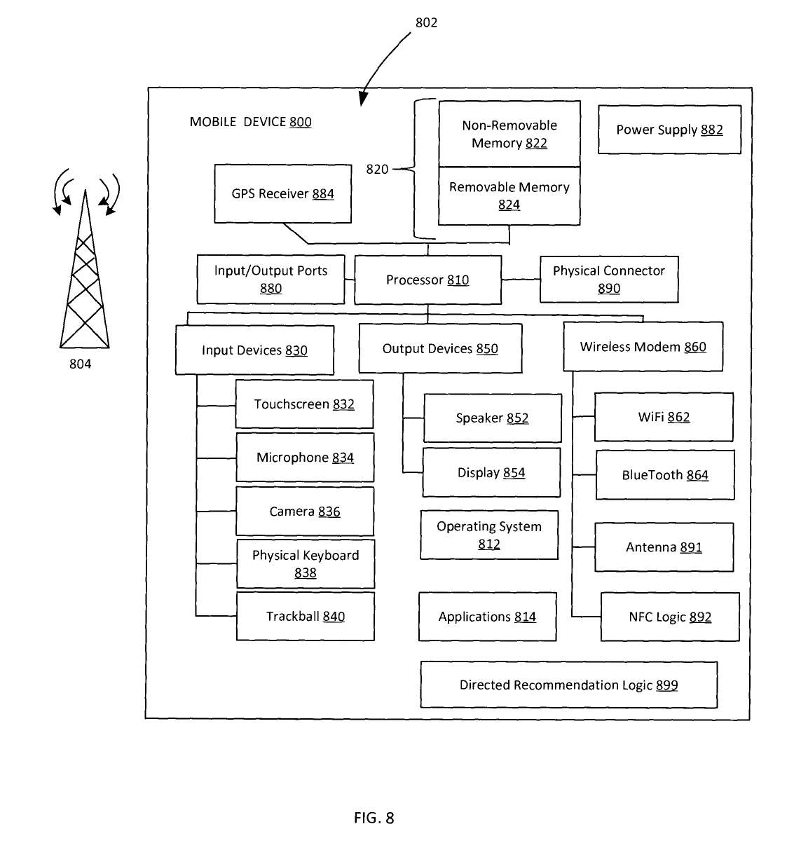

FIG. 8 is a system diagram depicting an exemplary mobile device 800 that includes a variety of optional hardware and software components, shown generally at 802. Components 802 in the mobile device 800 can communicate with other components, although not all connections are shown for ease of illustration. The mobile device 800 may be a variety of computing devices (e.g., cell phone, smartphone, handheld computer, Personal Digital Assistant (PDA), wearable computing device, etc.) and may allow wireless two-way communications with one or more mobile communications networks 804, such as a cellular or satellite network.

Mobile device 800 can include a controller or processor 810 (e.g., signal processor, microprocessor, ASIC, or other control and processing logic circuitry) for performing tasks including signal coding, data processing, input/output processing, power control, or other functions. An operating system 812 can control the allocation and usage of the components 802 and support application programs 814. The application programs 814 can include recommendation applications, directed recommendation applications, matrix factorization applications, sales data analytic applications, mobile computing applications (e.g., email applications, calendars, contact managers, web browsers, messaging applications), video games, or other computing applications.

Mobile device 800 can include memory 820. Memory 820 can include non-removable memory 822 or removable memory 824. The non-removable memory 822 can include random access memory (RAM), read only memory (ROM), flash memory, a hard disk, or other memory storage technologies. The removable memory 824 can include flash memory or a Subscriber Identity Module (SIM) card, which is well known in GSM communication systems, or other memory storage technologies, such as “smart cards.” The memory 820 can be used for storing data or code for running the operating system 812 and the applications 814. Example data can include source item vectors, target item vectors, latent space data, recommendations, directed recommendations, sales analytics data, or other data. The memory 820 can be used to store a subscriber identifier, such as an International Mobile Subscriber Identity (IMSI), and an equipment identifier, such as an International Mobile Equipment Identifier (IMEI). The identifiers can be transmitted to a network server to identify users or equipment.

The mobile device 800 can support one or more input devices 830 including, but not limited to, a touchscreen 832, a microphone 834, a camera 836, a physical keyboard 838, or trackball 840. The mobile device 800 may also support output devices 850 including, but not limited to, a speaker 852 and a display 854. Other possible output devices (not shown) can include piezoelectric or other haptic output devices. Some devices can serve more than one input/output function. For example, touchscreen 832 and display 854 can be combined in a single input/output device. The input devices 830 can include a Natural User Interface (NUI). An NUI is an interface technology that enables a user to interact with a device in a “natural” manner, free from artificial constraints imposed by input devices such as mice, keyboards, remote controls, and others. Examples of NUI methods include those relying on speech recognition, touch and stylus recognition, gesture recognition (both on screen and adjacent to the screen), air gestures, head and eye tracking, voice and speech, vision, touch, gestures, and machine intelligence. Other examples of a NUI include motion gesture detection using accelerometers/gyroscopes, facial recognition, three dimensional (3D) displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 812 or applications 814 can include speech-recognition software as part of a voice user interface that allows a user to operate the device 800 via voice commands. Further, the device 800 can include input devices and software that allow for user interaction via a user's spatial gestures, such as detecting and interpreting gestures to provide input to a recommendation application.

A wireless modem 860 can be coupled to an antenna 891. In some examples, radio frequency (RF) filters are used and the processor 810 need not select an antenna configuration for a selected frequency band. The wireless modem 860 can support two-way communications between the processor 810 and external devices. The modem 860 is shown generically and can include a cellular modem for communicating with the mobile communication network 804 and/or other radio-based modems (e.g., Bluetooth 864 or Wi-Fi 862). The wireless modem 860 may be configured for communication with one or more cellular networks, such as a Global system for mobile communications (GSM) network for data and voice communications within a single cellular network, between cellular networks, or between the mobile device and a public switched telephone network (PSTN). NFC logic 892 facilitates having near field communications (NFC).

The mobile device 800 may include at least one input/output port 880, a power supply 882, a satellite navigation system receiver 884, such as a Global Positioning System (GPS) receiver, or a physical connector 890, which can be a Universal Serial Bus (USB) port, IEEE 1394 (FireWire) port, RS-232 port, or other port. The illustrated components 802 are not required or all-inclusive, as other components can be deleted or added.

Mobile device 800 may include directed recommendation logic 899 that is configured to provide a functionality for the mobile device 800. For example, directed recommendation logic 899 may provide a client for interacting with a service (e.g., service 760, FIG. 7). Portions of the example methods described herein may be performed by directed recommendation logic 899. Similarly, directed recommendation logic 899 may implement portions of apparatus described herein.

The following includes definitions of selected terms employed herein. The definitions include various examples or forms of components that fall within the scope of a term and that may be used for implementation. The examples are not intended to be limiting. Both singular and plural forms of terms may be within the definitions.

References to “one embodiment”, “an embodiment”, “one example”, and “an example” indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Data store”, as used herein, refers to a physical or logical entity that can store electronic data. A data store may be, for example, a database, a table, a file, a list, a queue, a heap, a memory, a register, and other physical repository. In different examples, a data store may reside in one logical or physical entity or may be distributed between two or more logical or physical entities. Storing electronic data in a data store causes a physical transformation of the data store.

“Logic”, as used herein, includes but is not limited to hardware, firmware, software in execution on a machine, or combinations of each to perform a function(s) or an action(s), or to cause a function or action from another logic, method, or system. Logic may include a software controlled microprocessor, a discrete logic (e.g., ASIC), an analog circuit, a digital circuit, a programmed logic device, a memory device containing instructions, and other physical devices. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the Applicant intends to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one of, A, B, and C” is employed herein, (e.g., a data store configured to store one of, A, B, and C) it is intended to convey the set of possibilities A, B, and C, (e.g., the data store may store only A, only B, or only C). It is not intended to require one of A, one of B, and one of C. When the applicants intend to indicate “at least one of A, at least one of B, and at least one of C”, then the phrasing “at least one of A, at least one of B, and at least one of C” will be employed.

To the extent that the phrase “one or more of, A, B, and C” is employed herein, (e.g., a data store configured to store one or more of, A, B, and C) it is intended to convey the set of possibilities A, B, C, AB, AC, BC, ABC, AA . . . A, BB . . . B, CC . . . C, AA . . . ABB . . . B, AA . . . ACC . . . C, BB . . . BCC . . . C, or AA . . . ABB . . . BCC . . . C (e.g., the data store may store only A, only B, only C, A&B, A&C, B&C, A&B&C, or other combinations thereof including multiple instances of A, B, or C). It is not intended to require one of A, one of B, and one of C. When the applicants intend to indicate “at least one of A, at least one of B, and at least one of C”, then the phrasing “at least one of A, at least one of B, and at least one of C” will be employed.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus, comprising:
a processor;
a memory that stores non-transitive likelihood data associated with a directed recommendation;
a set of logics that produce the directed recommendation; and
an interface to connect the processor, the memory, and the set of logics;
the set of logics comprising:
a first logic that performs matrix factorization (MF) on a usage matrix to create a latent space that describes similarities between source items and target items in the usage matrix, where a source item is an item a user has acquired, and where a target item is an item a user may acquire;
where a source item in the usage matrix is represented by a source item latent vector sᵢ in the latent space, and where a target item in the usage matrix is represented by a target item latent vector tⱼ in the latent space,
where a source item x is related to a target item y by a value in a cell (x,y) in the usage matrix, x and y being integers, where the value stored in cell (x,y) describes the likelihood that an acquisition of item x will lead to an acquisition of item y, and where the value stored in cell (x,y) is not transitive with the value stored in cell (y,x);
a second logic that computes a value for a cell (p,q) in the usage matrix, p and q being integers, where the value for cell (p,q) is computed as a function of a vector in the latent space associated with a source item p in the usage matrix and a vector in the latent space associated with a target item q in the usage matrix; and
a third logic that, given an initial item (II) produces a directed recommendation of a recommended target item (RTI) based, at least in part, on data in the usage matrix, where a value v(II, RTI) in the usage matrix is not transitive with a value v(RTI,II) in the usage matrix.

2. The apparatus of claim 1, where a value of a cell (i,j) in the usage matrix is a probability Pr{i→j}, where i represents a source item and j represents a target item, i and j being integers, where Pr{i→j} is not determined by Pr{j→i}.

3. The apparatus of claim 2, where the first logic performs MF on the usage matrix to create a latent space that describes similarities between a basket of source items and a target item in the usage matrix, where a basket of source items includes two or more source items.

4. The apparatus of claim 2, where Pr{i→j} is defined according to:
Pr{i→j}=sᵢ·tⱼ,
where sᵢ·tⱼ represents the inner product of the source item vector sᵢ for item i and the target item vector tⱼ for item j.

5. The apparatus of claim 1, comprising a fourth logic that establishes an initial value for a cell in the usage matrix where the initial value is established from data associated with actual acquisitions of items represented in the usage matrix.

6. The apparatus of claim 1, where the dimensionality of the latent space is lower than the dimensionality of the usage matrix.

7. The apparatus of claim 1, where the second logic computes values for two or more cells in the usage matrix in parallel.

8. The apparatus of claim 1, where the third logic produces the directed recommendation based on a highest value v=Pr{II→RTI} found in the usage matrix.

9. The apparatus of claim 1, where the third logic produces N directed recommendations of N target items to acquire based on rankings of data found in the usage matrix for the initial item, N being an integer greater than one.

10. The apparatus of claim 1, where the initial item is an individual source item in the usage matrix.

11. The apparatus of claim 3, where the initial item is a plurality of source items in the usage matrix.

12. The apparatus of claim 1, where the initial item is associated with a user.

13. A method, comprising:
accessing a usage matrix (M) that stores electronic data concerning a set of source items i and a set of target items j, where the electronic data describes the likelihood that an acquisition of i will be followed by an acquisition of j, where i is described by a vector mᵢ and j is described by a vector mⱼ, and where the likelihood of acquiring j after i is not symmetrical with the likelihood of acquiring i after j;
producing, from M, first electronic data associated with a latent item space, where the first electronic data is produced using a matrix factorization process for vectors associated with members of the set of source items and vectors associated with members of the set of target items, where the first electronic data includes a vector uᵢ that represents i and a vector vⱼ that represents j, where the elements of a vector measure the extent to which the entity associated with the vector possesses the factors associated with the dimensions in M;
producing, from the first electronic data, second electronic data that represents a likelihood that an acquisition of a first item in M will be followed by an acquisition of a second item in M;
storing the second electronic data in M, and
producing a recommendation concerning an item in M to be acquired based, at least in part, on data in M.

14. The method of claim 13, comprising establishing M by storing a value in a cell (a,b) in M, a and b being integers, where the value stored in the cell (a,b) represents the likelihood that an acquisition of a source item a will lead to an acquisition of a target item b, where the value in cell (a,b) is based on actual acquisition data, and where the value in cell (a,b) is not symmetrical with the value in cell (b,a).

15. The method of claim 13, where the vector uᵢ has a smaller dimensionality than a vector mᵢ associated with item i in M.

16. The method of claim 13, where the likelihood that an acquisition of i will be followed by an acquisition of j is a probability Pr{i→j}, where Pr{i→j}≠Pr{j→i}, where Pr{i→j} is not transitive with Pr{j→i}, and where Pr{i→j} is not computed from Pr{j→i}.

17. The method of claim 16, where producing the second electronic data comprises producing a vector that represents a likelihood that an acquisition of a first set of items in M will be followed by an acquisition of a second item in M.

18. The method of claim 16, where Pr{i→j} is defined according to:
Pr{i→j}=sᵢ·tⱼ,
where sᵢ·tⱼ represents the inner product of the vector for i in the latent space and the vector for j in the latent space, and where producing the second electronic data depends, at least in part, on computing sᵢ·tⱼ.

19. The method of claim 18,
where the acquisition of i involves making a purchase, playing a game, reading a book, or watching a display, and
where producing the recommendation concerning the item to be acquired includes producing an item-to-item recommendation, a basket-to-item recommendation, or a user-to-item recommendation.

20. A computer-readable storage medium storing computer-executable instructions that when executed by a computer control the computer to perform a method, the method comprising:
establishing a usage matrix (M), where M stores electronic data concerning a set of source items i and a set of target items j, where the electronic data describes the likelihood that an acquisition of a source item i will be followed by an acquisition of a target item j, where i is described by a vector mᵢ and j is described by a vector mⱼ, and where the likelihood of acquiring j after i is not symmetrical with the likelihood of acquiring i after j, where the acquisition of i involves making a purchase, playing a game, reading a book, or watching a display;
where establishing M includes storing a value in a cell (a,b) in M, a and b being integers, where the value stored in the cell (a,b) represents the likelihood that an acquisition of a source item a will lead to an acquisition of a target item b, where the value in cell (a,b) is based on actual acquisition data, and where the value in cell (a,b) is not symmetrical with the value in cell (b,a);
accessing M;
producing, from M, first electronic data associated with a latent item space, where the first electronic data is produced using a matrix factorization process for vectors associated with members of the set of source items and vectors associated with members of the set of target items, where the first electronic data includes a vector uᵢ that represents i and a vector vⱼ that represents j, where the elements of a vector measure the extent to which the entity associated with the vector possesses the factors associated with the dimensions in M, where the vector uᵢ has a smaller dimensionality than a vector mᵢ associated with item i in M;
producing, from the first electronic data, second electronic data that represents a likelihood that an acquisition of a first item in M will be followed by an acquisition of a second item in M, where the likelihood that the acquisition i will be followed by the acquisition of j is a probability Pr{i→j}, where Pr{i→j}≠Pr{j→i}, where Pr{i→j} is not transitive with Pr{j→i}, where Pr{i→j} is not computed from Pr{j→i} and where Pr{i→j} is defined according to:
Pr{i→j}=sᵢ·tⱼ,
where sᵢ·tⱼ represents the inner product of the vector for i in the latent space and the vector for j in the latent space, and where producing the second electronic data depends, at least in part, on computing sᵢ·tⱼ;
storing the second electronic data in M, and
producing a recommendation concerning an item in M to be acquired based, at least in part, on data in M, where the recommendation is an item-to-item recommendation, a basket-to-item recommendation, or a user-to-item recommendation.
